(19) United States
(12) Patent Application Publication
(10) Pub. No.: US 2026/0093270 A1
(43) Pub. Date: Apr. 2, 2026

(54) CONTINGENCY LANDING SITE SELECTION BY UAV

(71) Applicant: Wing Aviation LLC, Palo Alto, CA (US)

(72) Inventors: ALI SHOEB, San Rafael, CA (US); KYLE JULIAN, Palo Alto, CA (US); LOUIS DRESSEL, Foster City, CA (US)

(21) Appl. No.: 18/899,849

(22) Filed: Sep. 27, 2024

(51) Int. Cl. G05D 1/654; G05D 1/622; G05D 109/20; G05D 111/10; G06T 7/10; G06T 7/50; G06V 10/26; G06V 20/17

(52) U.S. Cl. CPC G05D 1/6546; G05D 1/622; G06T 7/10; G06T 7/50; G06V 10/26; G06V 20/17; G05D 2109/20; G05D 2111/10; G06T 2207/10028; G06T 2207/10032; G06T 2207/20112

(57) ABSTRACT

A technique for managing an unplanned contingency landing of a unmanned aerial vehicle (UAV) includes determining by the UAV that the unplanned contingency landing is imminent, capturing aerial images of a ground area below the UAV with an onboard camera system as the UAV descends towards the ground area, semantically analyzing the aerial images to classify objects at the ground area into object classifications, depth analyzing the aerial images to determine above ground level (AGL) heights associated with each of the objects at the ground area, selecting a preferred landing site for the unplanned contingency landing that is coincident with one of the objects at the ground area based upon a contingency landing policy that ranks contingency landing sites based upon a combination of the object classifications and the AGL heights; and nudging the UAV towards the preferred landing site as the UAV descends towards the ground.

### TECHNICAL FIELD

This disclosure relates generally to unmanned aerial vehicles (UAVs), and in particular but not exclusively, relates to unplanned contingency landings by UAVs.

### BACKGROUND INFORMATION

An unmanned vehicle, which may also be referred to as an autonomous vehicle, is a vehicle capable of traveling without a physically present human operator. Various types of unmanned vehicles exist for various different environments. For instance, unmanned vehicles exist for operation in the air, on the ground, underwater, and in space. Unmanned vehicles also exist for hybrid operations in which multi-environment operation is possible. Unmanned vehicles may be provisioned to perform various different missions, including payload delivery, exploration/reconnaissance, imaging, public safety, surveillance, or otherwise. The mission definition will often dictate a type of specialized equipment and/or configuration of the unmanned vehicle.

Unmanned aerial vehicles (also referred to as drones) can be adapted for package delivery missions to provide an aerial delivery service. One type of unmanned aerial vehicle (UAV) is a vertical takeoff and landing (VTOL) UAV. VTOL UAVs are particularly well-suited for package delivery missions. The VTOL capability enables a UAV to takeoff and land within a small footprint thereby facilitating package pick-ups and deliveries almost anywhere.

In rare occasions, a UAV may be forced into an emergency landing referred to herein as an unplanned contingency landing. During some unplanned contingency landings, the UAV may retain at least partial control authority even though the landing may be urgent and non-optional. Where the UAV retains at least some control authority, it is desirable to intelligently select amongst available landing sites.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1 illustrates operation of an unmanned aerial vehicle (UAV) delivery service that delivers packages into a neighborhood, in accordance with an embodiment of the disclosure.

FIG. 2 is a functional block diagram illustrating a system for navigating a UAV and selection of a preferred landing site during an unplanned contingency landing, in accordance with an embodiment of the disclosure.

FIG. 3 is a flow chart illustrating a process for selecting a preferred landing site during an unplanned contingency landing, in accordance with an embodiment of the disclosure.

FIG. 4A illustrates an aerial image of a ground area including an initial do-nothing landing site and a revised preferred landing site, in accordance with an embodiment of the disclosure.

FIG. 4B illustrates a contingency landing map where the ground area below a UAV is classified into obstacle regions to avoid and non-obstacle regions deemed acceptable for contingency landing, in accordance with an embodiment of the disclosure.

FIG. 5A is a perspective view illustration of a UAV configured for use in a UAV delivery system, in accordance with an embodiment of the disclosure.

FIG. 5B is an underside plan view illustration of the UAV configured for use in the UAV delivery system, in accordance with an embodiment of the disclosure.

### DETAILED DESCRIPTION

Embodiments of a system, apparatus, and method of operation for preferred site selection during an unplanned contingency landing of an unmanned aerial vehicle (UAV) are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

UAV delivery services are expected to operate in populated areas, including suburban neighborhoods. Occasionally, a UAV may encounter an emergency situation where the UAV is forced into an urgent, non-optional, and unplanned contingency landing, (also referred to as a “contingency landing”). A contingency landing is a landing that was not planned for nor included in the mission plan. The contingency landing is typically urgent, non-optional, and unavoidable once commenced. Contingency landings are expected to be rare, emergency situations. When a UAV determines it is executing a contingency landing, but retains at least some control authority (i.e., at least some influence over its landing site selection), the UAV should quickly select a preferred landing site from those that are reasonably available. A preferred landing site is one that is selected based upon a contingency landing policy. As described herein, the contingency landing policy seeks to reduce risks to life and property while also considering ease of retrieval and the minimization of structural harm to the aircraft itself. For example, the contingency landing policy may actively seek to avoid roads, vehicles (e.g., cars, trucks, motorcycles, etc.), and utility lines while gravitating towards landing sites occupied by trees and shrubs (most preferred) or even building roofs (less preferred). However, when multiple preferred landing sites are reasonably obtainable given the UAVs altitude, descend rate, and/or remaining control authority, then the contingency landing policy described herein also considers ease of retrieval in addition to public safety and preservation of property including the UAV.

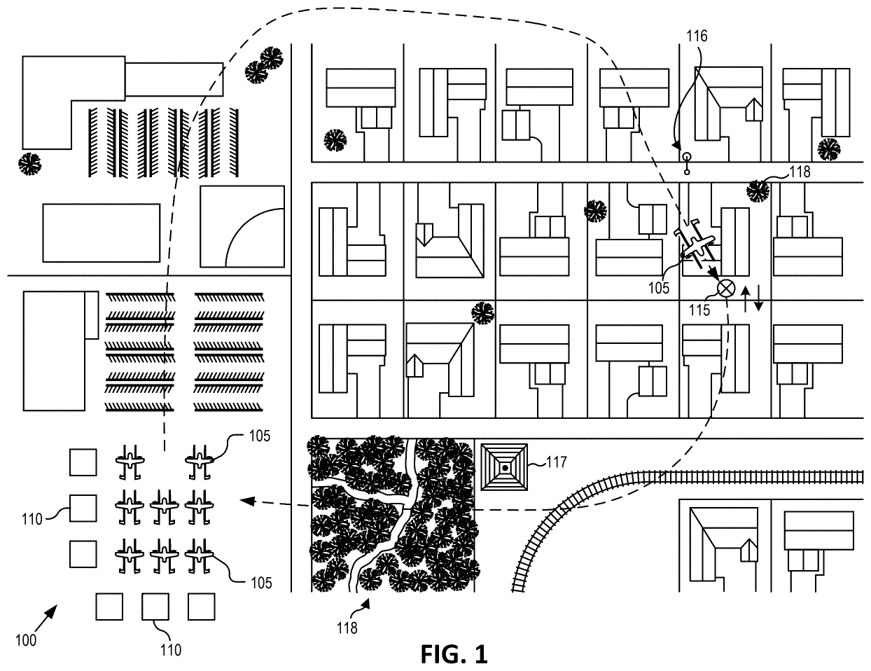

FIG. 1 illustrates operation of a UAV delivery service that delivers packages into a neighborhood, in accordance with an embodiment of the disclosure. UAVs may one day routinely deliver items into urban or suburban neighborhoods from small regional or neighborhood hubs such as terminal area 100 (also referred to as a local nest or staging area). Vendor facilities that wish to take advantage of the aerial delivery service may set up adjacent to terminal area 100 (such as vendor facilities 110) or be dispersed throughout the neighborhood for waypoint package pickups (not illustrated). An example aerial delivery mission may include multiple mission phases such as takeoff from terminal area 100 with a package for delivery to a destination area 115 (also referred to as a delivery zone, drop zone, or delivery destination), rising to a cruising altitude, and cruising to the customer destination. At destination area 115, UAV 105 descends for package drop-off before once again ascending to a cruise altitude for the return cruise back to terminal area 100. The delivery mission is preplanned.

During the course of a delivery mission, ground-based obstacles are an ever-present hazard—particularly tall slender obstacles such as streetlights 116, telephone poles, radio towers 117, cranes, trees 118, etc. Some of these obstacles may be persistent unchanging obstacles (e.g., streetlights, telephone poles, radio towers, etc.) while others may be temporary (cranes, etc.), or ever changing/growing (e.g., trees). While trees 118 and building roofs are avoided as obstacles during execution of the planned mission, trees, shrubs, and building roofs may be designated as preferred landing sites during unplanned contingency landings. Although the techniques disclosed herein are described in connection with a UAV delivery service, it should be appreciated that they are equally applicable to other types of UAV services that execute other missions (e.g., public safety mission, aerial photography missions, etc.).

The delivery mission is planned and uploaded into a selected UAV 105 with its mission data. In rare scenarios, an emergency may occur during execution of the delivery mission that forces UAV 105 into an unplanned contingency landing. A contingency landing may result from a low charge or failing battery, a cross-track issue where UAV 105 is off course and can't get back on track, UAV 105 senses large unintentional accelerations (e.g., rapid descent), senses a control saturation condition where maximal thrust or control surface application isn't achieving expected results, UAV 105 becomes aware of a close encounter with another aircraft, UAV 105 has lost localization and can no longer identify its location (e.g., GNSS and visual localization are impeded), UAV 105 receives a remote land now command, or otherwise. In many of these situations, UAV 105 may still retain at least some control authority to influence selection of a preferred landing site as opposed to simply accepting a do-nothing landing site that will result from its current trajectory.

As mentioned above, the preferred landing site is selected based upon a contingency landing policy and the landing sites reasonably available to it. The reasonably available landing sites are landing sites within a maximum deviation perimeter around its do-nothing landing site. For example, if UAV 105 is cruising/hovering at 50 m above ground level (AGL) altitude when an unplanned contingency landing is deemed imminent, then the reasonably available landing sites may be those sites that fall within a 7 m radius surrounding its initially determined do-nothing landing site. Of course, other radius values or maximum perimeter shapes may be implemented, and the size or shape of the maximum deviation perimeter may even change depending upon AGL altitude and speed over ground (SOG). In one embodiment, the contingency landing policy disprefers roads, vehicles, and utility lines while preferring sites occupied by trees and shrubs or even building roofs that fall within the maximum deviation perimeter (e.g., 7 m radius). Within preferred landing sites, the contingency landing policy has further preference for sites where preferred objects (e.g., trees, shrubs, roofs) have heights falling within a limited height range that starts above the height of an average human adult. For example, the limited height range includes objects ranging in height from 3 m to 5 m. This range places the landing site safely above the height of people while also prioritizing ease of recovery (compared to recovery from a 70 ft tree). Of course, other ranges may be implemented. Accordingly, in one embodiment, the contingency landing policy prefers landing sites classified as containing a tree, a shrub, or even a building roof that ranges in AGL heights of approximately 3 m to 5 m. In one embodiment, the contingency landing policy further seeks to affirmatively avoid landing on roads, utility lines, and vehicles even more so than other possible landing sites such as lawns, yards, sidewalks, or water bodies, which may be considered neutral contingency landing sites. Thus, when a preferred object falls within the maximum deviation perimeter of the do-nothing landing site, UAV 105 will affirmatively nudge its position towards the preferred landing site with the preferred object versus landing on dispreferred or neutral objects. The minimization of structural harm directive may further include preferences between neutral sites for self-preservation. For example, if the only available options for landing are between a lawn or a sidewalk, the contingency landing policy may prefer the softer lawn area over the hard sidewalk to minimize structural harm.

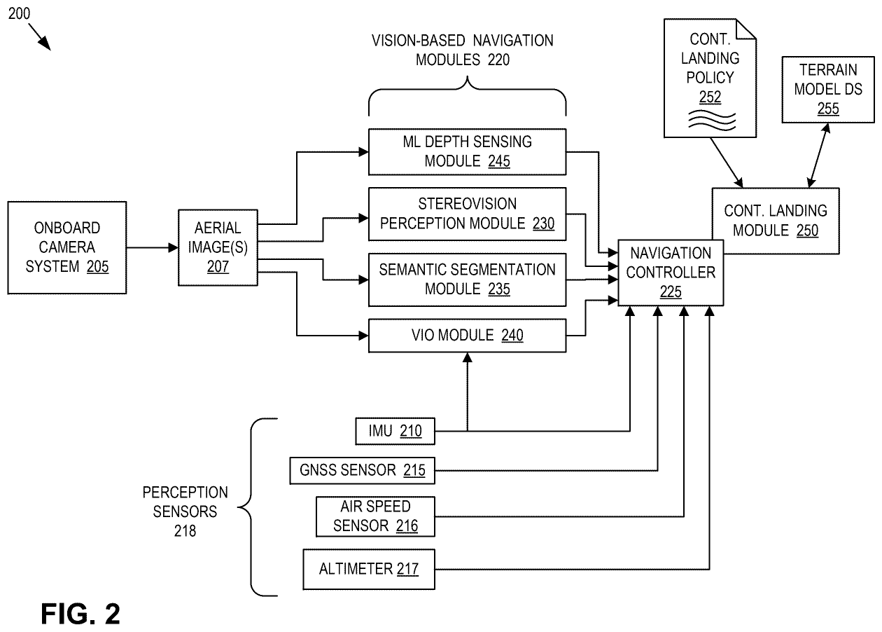

FIG. 2 is a functional block diagram illustrating a system 200 for navigating a UAV 105 and selection of a preferred landing site during an unplanned contingency landing, in accordance with an embodiment of the disclosure. System 200 includes many of the relevant software and hardware elements onboard UAVs 105 for sensing the environment and navigating. The illustrated embodiment of system 200 includes an onboard camera system 205 for acquiring aerial images 207, an inertial measurement unit (IMU) 210, a global navigation satellite system (GNSS) sensor 215, an air speed sensor 216 (e.g., pitot tube), an altimeter 217 (e.g., air pressure sensor), vision-based navigation modules 220, and a navigation controller 225. Collectively, the sensors 210-217 are referred to as perception sensors 218. The illustrated embodiment of vision-based navigation modules 220 includes a stereovision perception module 230, a semantic segmentation module 235, a visual inertial odometry (VIO) module 240, and a machine learning (ML) depth sensing module 245. Navigation controller 225 includes, amongst other logic, a contingency landing module 250 which references a contingency landing policy 252 and a terrain model data structure 255.

Onboard camera system 205 is disposed on UAVs 105 with a downward looking position to acquire aerial images 207. Aerial images 207 may be acquired at a regular video frame rate (e.g., 20 f/s, 30 f/s, etc.) and a subset of the images provided to the various vision-based navigation modules 220 for analysis. In one embodiment, onboard camera system 205 is a stereovision camera system. While capturing aerial images 207, the camera intrinsics along with sensor readings from the onboard perception sensors 218 may be recorded and indexed to aerial images 207. For example, IMU 210 may include one or more of an accelerometer, a gyroscope, or a magnetometer to capture accelerations (linear or rotational), attitude, and heading readings. GNSS sensor 215 may be a global positioning system (GPS) sensor, or otherwise, and output longitude/latitude position, mean sea level (MSL) altitude, heading, speed over ground (SOG), etc. Air speed sensor 216 captures air speed of UAV 105 while underway, which may serve as a rough approximation for SOG when adjusted for weather conditions. Altimeter 217 measures air pressure, which provides MSL altitude, which may be offset using elevation map data to estimate above ground level (AGL) altitude.

During flight missions, vision-based navigation modules 220 are operated as part of an onboard machine vision system and may constantly receive aerial images 207 and identify objects represented in those aerial images (e.g., pixelwise classification). Stereovision perception module 230 analyzes parallax between stereovision aerial images acquired by onboard camera system 205 to estimate distance to pixels/features/objects in aerial images 207. These stereovision depth estimates may be referred to as a stereovision depth map. VIO module 240 estimates the three-dimensional (3D) pose (e.g., position/orientation) of onboard camera system 205 of UAV 105 using aerial images 207 and IMU 210. In other words, VIO module 204 provides ego-motion tracking relative to the surrounding environment of UAV 105. Semantic segmentation module 235 uses image segmentation to inform object identification (e.g., pixelwise classification) and feature tracking within aerial images 207. Feature tracking includes the identification and tracking of features within aerial images 207. Features may include edges, corners, high contrast points, etc. of objects within aerial images 207. Recognized objects may be tracked and the classifications provided to other modules responsible for making real-time flight decisions. Finally, ML depth sensing module 245 uses a neural network trained to estimate depth to objects imaged in aerial images 207 (i.e., offset distance between imaged objects and onboard camera system 205). ML depth sensing module 245 may be trained to sense depth using aerial images tagged with depth labels. Such ground truth data may be collected by flying training missions with onboard lidar to capture aerial images indexed to lidar depth readings.

Collectively, vision-based navigation modules 220 provide vision-based analysis and understanding of the surrounding environment, which may be used by navigation controller 225 to inform navigation decisions and perform localization, automated obstacle avoidance, route traversal, etc. Of course, the output from the vision-based navigation modules 220 may be combined with, or considered in connection with, real-time data from any of perception sensors 218 by navigation controller 225 to make informed vision-based navigation decisions. One of these informed vision-based navigation decisions is selection of a preferred landing site when an unplanned contingency landing is deemed imminent.

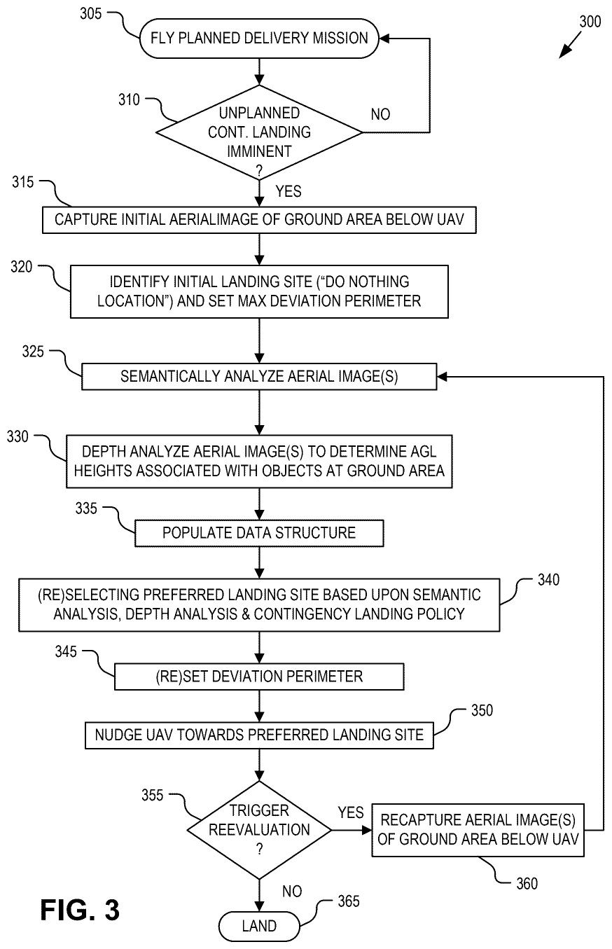

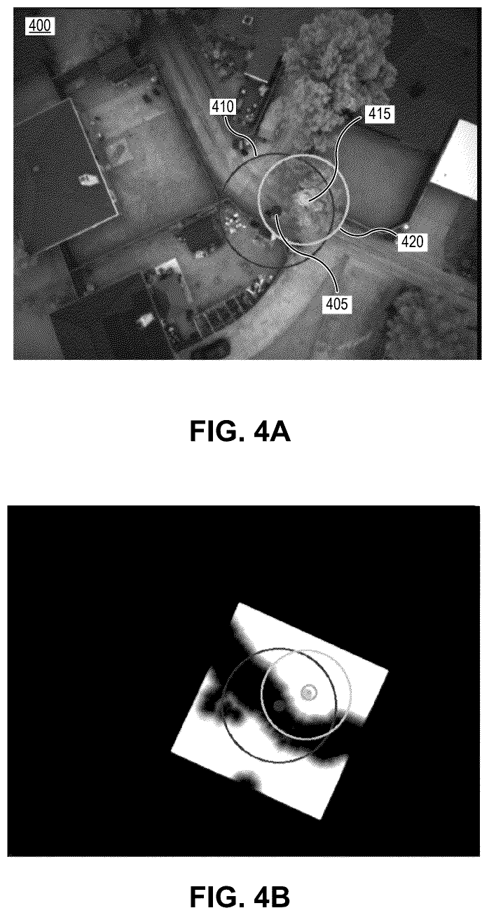

FIG. 3 is a flow chart illustrating a process 300 for selecting a preferred landing site during an unplanned contingency landing, in accordance with an embodiment of the disclosure. Process 300 is described with reference to FIGS. 2, 4A, and 4B. The order in which some or all of the process blocks appear in process 300 should not be deemed limiting. Rather, one of ordinary skill in the art having the benefit of the present disclosure will understand that some of the process blocks may be executed in a variety of orders not illustrated, or even in parallel.

In a process block 305, UAV 105 is executing a planned delivery mission, such as the one described in connection with FIG. 1 to deliver a package to delivery destination 115. The delivery mission itself is preplanned and the mission data is uploaded to UAV 105 from a backend management system prior to commencement of the delivery mission. At some point during the delivery mission, an emergency may arise forcing UAV 105 into an unplanned contingency landing. The reasons for such contingency landings can be diverse. For example, a contingency landing may be executed when the battery of UAV 105 is prematurely near depletion and insufficient to complete the mission. Another example is the onset of control saturation that persists for a threshold period of time. Control saturation includes a control surface being fully engaged and/or propulsion thrust at or near 100%, but UAV 105 is not able to achieve the desired navigation result. Another example includes UAV 105 losing the ability to localize itself. This may include the loss of both primary localization (e.g., GNSS) and secondary localizations (e.g., vision-based localization). If UAV 105 loses localization such that it is unable to determine its location for a threshold period of time, then it may be forced into a contingency landing. Yet other examples include an uncontrolled acceleration measured by IMU 210 that exceeds safety thresholds (e.g., indicative of a rapid descent or midair collision), sensing a close encounter with an obstacle, sensing a persistent and unresolved airspace conflict for a threshold period of time with another aircraft, or simply receiving an emergency land now instruction. Of course, the above list of reasons is not exhaustive and it is anticipated that other reasons could arise. Regardless of the reason, if the onboard perception sensors 218 or navigation controller 225 of UAV 105 determine that an unplanned contingency landing is imminent, then process 300 continues to a process block 315.

In process block 315, UAV 105 captures one or more initial aerial images 207 of the ground area below its position when it determines a contingency landing is imminent. FIG. 4A illustrates an example aerial image 400. With the initial aerial image captured and knowledge of its current flight dynamics (SOG, direction, altitude loss, etc.), contingency landing module 250 identifies an initial landing site 405 that is deemed likely for the unplanned contingency landing should UAV 105 do nothing to change its current trajectory (process block 320). The initial landing site 405 is also referred to as the do-nothing landing site. In connection with identifying the do-nothing landing site, contingency landing module 250 sets a maximum deviation perimeter 410 around the do-nothing landing site 405. In one embodiment, maximum deviation perimeter 410 is a circle of a defined radius (e.g., 7 m). In other embodiments, maximum deviation perimeter 410 may assume other shapes (e.g., ellipse, etc.) dependent upon flight dynamics present at the time (e.g., is UAV 105 hovering or cruising, etc.). In one embodiment, the size of maximum deviation perimeter 410 may also be dependent upon the initial AGL altitude of UAV 105 when contingency landing is first deemed to be imminent. The maximum deviation perimeter 410 represents a sort of guard rail to the selection of a preferred landing site. Any subsequent revision or reevaluation of the preferred landing site is constrained to remain within maximum deviation perimeter 410. Maximum deviation perimeter 410 ensures that the selection and possible revision of the preferred landing site remains within a reasonably obtainable distance to the do-nothing landing site. Limiting the radius for reevaluating subsequent preferred landing sites also limits erratic last second changes that may not be feasible.

In a process block 325, contingency landing module 250 obtains a semantic analysis of aerial image 400 from semantic segmentation module 235 to classify objects at the ground area captured by aerial image 400 into object classifications. In one embodiment, semantic segmentation module 235 classifies each image pixel as being a member of an object category. For example, semantic segmentation module 235 may classify the image pixels as being a member of one or more of: a lawn, a road, a vehicle, a sidewalk, a driveway, a building roof, a utility line, a streetlight, a pole, a fence, a water body, a tree, a shrub, etc. The semantic analysis may further categorize the ground area (on a pixel-by-pixel basis) into obstacle regions and non-obstacle regions. Obstacle regions include roads, vehicles, utility lines, or any region to be avoided during an unplanned contingency landing. Non-obstacle regions include trees, shrubs, building rooftops, or any region that is deemed acceptable to land on during an unplanned contingency landing. The categorization of each pixel of aerial image 400 into an obstacle or non-obstacle can be used to generate contingency landing map 401 illustrated in FIG. 4B. In one embodiment, contingency landing map 401 is a binary map indicating go/no go regions. In other embodiments, contingency landing map 401 may be a heat map with granular shades indicating relative preferences for landing sites. In one embodiment, the granular shades may be based upon relative preferences between different object classifications (e.g., tree vs lawn) as determined in process block 325 and/or relative preferences of measured AGL heights (e.g., does the object fall within the 3 m-5 m preferred height range) as determined in a process block 330 discussed next. In the illustrated embodiment of FIG. 4B, white represents non-obstacle regions deemed acceptable for a contingency landing while black represents obstacle regions to avoid during a contingency landing.

In process block 330, aerial images 207 (or 400) are analyzed to determine the AGL heights of each object at the ground area. The AGL heights may be determined by depth analyzing aerial images 207 and then subtracting the determined depth from the AGL altitude of UAV 105. In one embodiment, the depth analysis is performed using ML depth sensing module 245 though a depth map output from stereovision perception module 230 may also be referenced. Of course, other depth sensing techniques (e.g., optical flow, etc.) may also be used. In one embodiment, the depth analysis provides a pixelwise depth map for aerial images 207, which is then translated into AGL height based upon the current AGL altitude of UAV 105.

The outputs from the semantic and depth analyses performed in process blocks 325 and 330 may be populated into a data structure (DS), such as terrain model DS 255, in real-time as UAV 105 descends. For example, terrain model DS 255 may be an octree DS for storing the object classifications and AGL heights. In one embodiment, the octree DS labels voxels within a volume above the ground area with the object classifications and AGL heights. As UAV 105 descends, the voxels may be updated as the object classifications and AGL heights are refined with closer proximity to the ground.

In a process block 340, a preferred landing site for the unplanned contingency landing is selected. This selection is based upon the contingency landing policy, which ranks contingency landing sites based upon a combination of the object classifications and AGL heights. FIG. 4A illustrates a preferred landing site 415, which happens to be in a tree having a preferred height (e.g., 3 m-5 m tall). When selecting preferred landing site 415, a revised deviation perimeter 420 extending around preferred landing site 415 is also set (process block 345). Revised deviation perimeter 420 is smaller than maximum deviation perimeter 410. For example, revised deviation perimeter 420 may have a radius of 3 m or 5 m. With a preferred landing site 415 selected, navigation controller 225 nudges UAV 105 towards the preferred landing site 415 as UAV 105 descends towards the ground (process block 350). The extent of nudging will depend upon the amount of control authority UAV 105 retains during the unplanned contingency landing.

The selection of a preferred landing site need not be a one time selection. Rather, evaluation/selection may be iterative in successive, discrete intervals while UAV 105 descends towards the ground (decision block 355). In one embodiment, a discrete reevaluation is triggered based upon passing through one of several AGL altitude thresholds (e.g., 50 m, 32 m, 5 m). The reevaluation may be triggered in discrete intervals to give each nudging effort an opportunity to have effect on the trajectory of UAV 105 before another reevaluation. Upon triggering a reevaluation, a new aerial image 207 is acquired at the new altitude (process block 360) upon which revised semantic and depth analyses are performed (process blocks 325 & 330) and the revised classifications and AGL height data are populated into terrain model DS 255. The updated data is then used to revise the preferred landing site and revise the deviation perimeter. In one embodiment, each revised preferred landing site resides within the maximum deviation perimeter and all previously set revised deviation perimeters and each revised deviation perimeter is successively smaller than the previous deviation perimeter(s). In one embodiment, terrain model DS 255 may be continuously populated with updated classification and AGL height data while reevaluations of the preferred landing site are triggered at specified intervals. Finally, UAV 105 lands in process block 365. Depending upon the amount of control authority available during the contingency landing, characterization of the landing may range between a fully controlled expeditious landing to a marginally controlled crash landing.

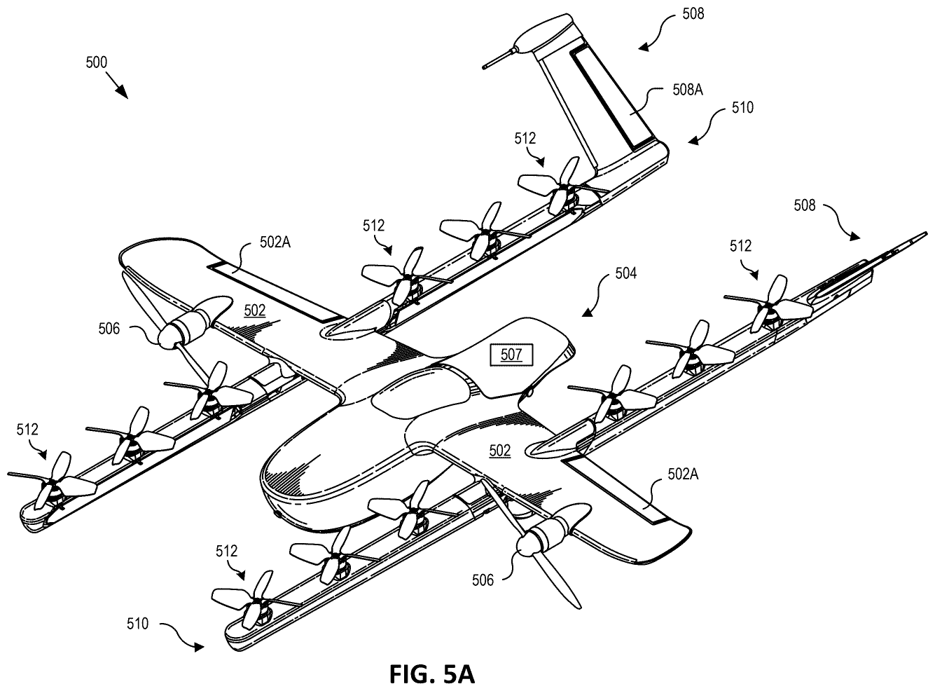

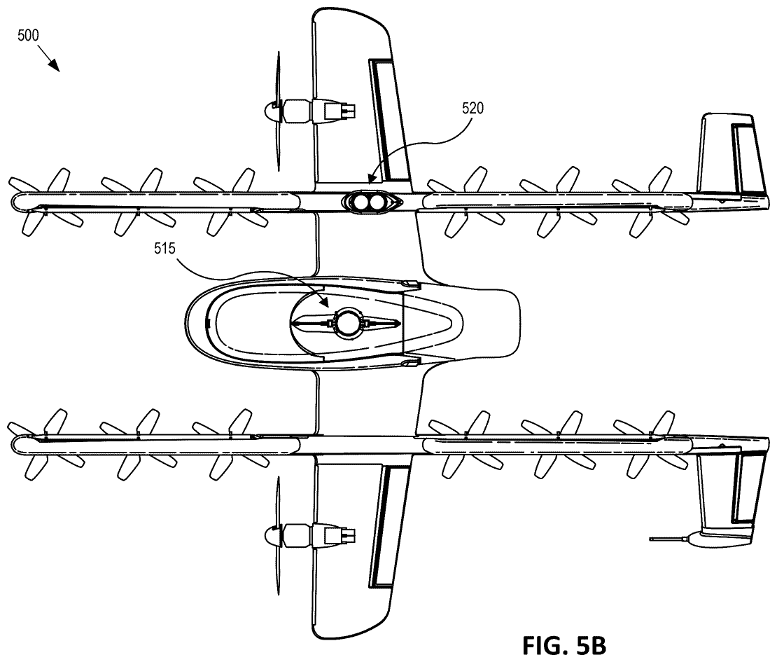

FIGS. 5A and 5B illustrate a UAV 500 that is well-suited for delivery of packages, in accordance with an embodiment of the disclosure. FIG. 5A is a topside perspective view illustration of UAV 500 while FIG. 5B is a bottom side plan view illustration of the same. UAV 500 is one possible implementation of UAVs 105 illustrated in FIG. 1, although other types of UAVs may be implemented for a UAV delivery service as well.

The illustrated embodiment of UAV 500 is a vertical takeoff and landing (VTOL) UAV that includes separate propulsion units 506 and 512 for providing horizontal and vertical propulsion, respectively. UAV 500 is a fixed-wing aerial vehicle, which as the name implies, has a wing assembly 502 that can generate lift based on the wing shape and the vehicle's forward airspeed when propelled horizontally by propulsion units 506. The illustrated embodiment of UAV 500 has an airframe that includes a fuselage 504 and wing assembly 502. In one embodiment, fuselage 504 is modular and includes a battery module, an avionics module, and a mission payload module. These modules are secured together to form the fuselage or main body.

The battery module (e.g., fore portion of fuselage 504) includes a cavity for housing one or more batteries for powering UAV 500. The avionics module (e.g., aft portion of fuselage 504) houses flight control circuitry of UAV 500, which may include a processor and memory, communication electronics and antennas (e.g., cellular transceiver, wifi transceiver, etc.), and various sensors (e.g., GNSS sensor, an inertial measurement unit, a magnetic compass, a radio frequency identifier reader, etc.). Collectively, these functional electronic subsystems for controlling UAV 500, communicating, and sensing the environment may be referred to as a control system 507. The mission payload module (e.g., middle portion of fuselage 504) houses equipment associated with a mission of UAV 500. For example, the mission payload module may include a payload actuator 515 (see FIG. 5B) for holding and releasing an externally attached payload (e.g., package for delivery). In some embodiments, the mission payload module may include camera/sensor equipment (e.g., camera, lenses, radar, lidar, pollution monitoring sensors, weather monitoring sensors, scanners, etc.). In FIG. 5B, an onboard camera 520 (e.g., onboard camera system) is mounted to the underside of UAV 500 to support a computer vision system (e.g., stereoscopic machine vision) for visual triangulation and navigation as well as operate as an optical code scanner for reading visual codes affixed to packages. These visual codes may be associated with or otherwise match to delivery missions and provide the UAV with a handle for accessing destination, delivery, and package validation information. Of course, onboard camera 520 may alternatively be integrated within fuselage 504.

As illustrated, UAV 500 includes horizontal propulsion units 506 positioned on wing assembly 502 for propelling UAV 500 horizontally. UAV 500 further includes two boom assemblies 510 that secure to wing assembly 502. Vertical propulsion units 512 are mounted to boom assemblies 510. Vertical propulsion units 512 providing vertical propulsion. Vertical propulsion units 512 may be used during a hover mode where UAV 500 is descending (e.g., to a delivery zone), ascending (e.g., at initial launch or following a delivery), or maintaining a constant altitude. Stabilizers 508 (or tails) may be included with UAV 500 to control pitch and stabilize the aerial vehicle's yaw (left or right turns) during cruise. In some embodiments, during cruise mode vertical propulsion units 512 are disabled or powered low and during hover mode horizontal propulsion units 506 are disabled or powered low.

During flight, UAV 500 may control the direction and/or speed of its movement by controlling its pitch, roll, yaw, and/or altitude. Thrust from horizontal propulsion units 506 is used to control air speed. For example, the stabilizers 508 may include one or more rudders 508A for controlling the aerial vehicle's yaw, and wing assembly 502 may include elevators for controlling the aerial vehicle's pitch and/or ailerons 502A for controlling the aerial vehicle's roll. Rudders 508A and ailerons 502A are referred to as control surfaces. While the techniques described herein are particularly well-suited for VTOLs providing an aerial delivery service, it should be appreciated that the techniques described herein are generally applicable to a variety of aircraft types (not limited to VTOLs) providing a variety of services or serving a variety of functions beyond package deliveries.

Many variations on the illustrated fixed-wing aerial vehicle are possible. For instance, aerial vehicles with more wings (e.g., an “x-wing” configuration with four wings), are also possible. Although FIGS. 5A and 5B illustrate one wing assembly 502, two boom assemblies 510, two horizontal propulsion units 506, and six vertical propulsion units 512 per boom assembly 510, it should be appreciated that other variants of UAV 500 may be implemented with more or less of these components.

It should be understood that references herein to an “unmanned” aerial vehicle or UAV can apply equally to autonomous and semi-autonomous aerial vehicles. In a fully autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator may control high level navigation decisions for a UAV, such as specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

1. A method implemented by an unmanned aerial vehicle (UAV) during an unplanned contingency landing, the method comprising:
determining by the UAV that the unplanned contingency landing is imminent;
capturing aerial images of a ground area below the UAV with an onboard camera system of the UAV as the UAV descends towards the ground area;
semantically analyzing the aerial images to identify and classify objects at the ground area into object classifications;
depth analyzing the aerial images to determine above ground level (AGL) heights associated with each of the objects identified at the ground area;
selecting a preferred landing site for the unplanned contingency landing that is coincident with one of the objects identified at the ground area based upon a contingency landing policy that ranks contingency landing sites based upon a combination of the object classifications and the AGL heights associated with the objects identified at the ground area; and
nudging the UAV towards the preferred landing site as the UAV descends towards the ground area.

2. The method of claim 1, wherein the contingency landing policy prefers the contingency landing sites where the objects have object heights above a ground level that fall within a limited height range that starts above a height of an average human adult.

3. The method of claim 2, wherein the limited height range includes 3 m to 5 m above the ground level.

4. The method of claim 1, wherein the contingency landing policy prefers the contingency landing sites where the objects are classified as a tree, a shrub, or a building roof.

5. The method of claim 4, wherein the continency landing policy disprefers the contingency landing sites where the objects are classified as a road, a utility line, or a vehicle.

6. The method of claim 1, wherein semantically analyzing the one or more aerial images classifies the ground area into obstacle regions and non-obstacle regions, wherein the obstacle regions comprise first areas to avoid landing on during the unplanned contingency landing and the non-obstacle regions comprise second areas deemed acceptable to land on during the unplanned contingency landing.

7. The method of claim 1, further comprising:
identifying an initial landing site deemed likely for the unplanned contingency landing should the UAV do nothing to affirmatively change a trajectory of the unplanned contingency landing; and
setting a maximum deviation perimeter around the initial landing site,
wherein any revision of the preferred landing site made during the unplanned contingency landing is constrained to remain within the maximum deviation perimeter.

8. The method of claim 7, further comprising:
selecting a revised preferred landing site after descending from an initial AGL altitude of the UAV at an onset of the unplanned contingency landing; and
setting a revised deviation perimeter around the revised preferred landing site, wherein the revised deviation perimeter is smaller than the maximum deviation perimeter.

9. The method of claim 7, further comprising:
selecting a plurality of revised preferred landing sites and setting a plurality of revised deviation perimeters in successive, discrete intervals while descending towards the ground area during the unplanned contingency landing,
wherein each of the revised preferred landing sites resides within the maximum deviation perimeter and all previously set revised deviation perimeters,
wherein each of the revised deviation perimeters are successively smaller.

10. The method of claim 9, wherein the successive, discrete intervals are triggered based on an altitude of the UAV.

11. The method of claim 1, further comprising:
populating an octree data structure with the object classifications and the AGL heights as the UAV descends toward the ground area during the unplanned contingency landing, wherein the octree data structure labels voxels within a volume above the ground area with the object classifications and the AGL heights.

12. The method of claim 1, wherein the determining by the UAV that the unplanned contingency landing is imminent comprises at least one of:
determining that a battery of the UAV is near depletion;
identifying control saturation that persists for a threshold period;
determining that localization of the UAV is lost;
sensing an uncontrolled threshold acceleration;
sensing a close encounter or airspace conflict; or
receiving an emergency land now instruction.

13. At least one non-transitory machine-readable storage medium having instructions stored thereon that, in response to execution by an unmanned aerial vehicle (UAV), cause the UAV to perform operations comprising:
determining by the UAV that an unplanned contingency landing is imminent;
capturing aerial images of a ground area below the UAV with an onboard camera system of the UAV as the UAV descends towards the ground area;
semantically analyzing the aerial images to identify and classify objects at the ground area into object classifications;
depth analyzing the aerial images to determine above ground level (AGL) heights associated with each of the objects identified at the ground area;
selecting a preferred landing site for the unplanned contingency landing that is coincident with one of the objects identified at the ground area based upon a contingency landing policy that ranks contingency landing sites based upon a combination of the object classifications and the AGL heights associated with the objects identified at the ground area; and
nudging the UAV towards the preferred landing site as the UAV descends towards the ground area.

14. The at least one non-transitory machine-readable storage medium of claim 13, wherein the contingency landing policy prefers the contingency landing sites where the objects have object heights above a ground level that fall within a limited height range that starts above a height of an average human adult.

15. The at least one non-transitory machine-readable storage medium of claim 13, wherein the contingency landing policy prefers the contingency landing sites where the objects are classified as a tree, a shrub, or a building roof.

16. The at least one non-transitory machine-readable storage medium of claim 15, wherein the continency landing policy disprefers the contingency landing sites where the objects are classified as a road, a utility line, or a vehicle.

17. The at least one non-transitory machine-readable storage medium of claim 13, wherein semantically analyzing the one or more aerial images classifies the ground area into obstacle regions and non-obstacle regions, wherein the obstacle regions comprise first areas to avoid landing on during the unplanned contingency landing and the non-obstacle regions comprise second areas deemed acceptable to land on during the unplanned contingency landing.

18. The at least one non-transitory machine-readable storage medium of claim 13, wherein the operations further comprise:
identifying an initial landing site deemed likely for the unplanned contingency landing should the UAV do nothing to affirmatively change a trajectory of the unplanned contingency landing; and
setting a maximum deviation perimeter around the initial landing site,
wherein any revision of the preferred landing site made during the unplanned contingency landing is constrained to remain within the maximum deviation perimeter.

19. The at least one non-transitory machine-readable storage medium of claim 18, wherein the operations further comprise:
selecting a revised preferred landing site after descending from an initial AGL altitude of the UAV at an onset of the unplanned contingency landing; and
setting a revised deviation perimeter around the revised preferred landing site, wherein the revised deviation perimeter is smaller than the maximum deviation perimeter.

20. The at least one non-transitory machine-readable storage medium of claim 18, wherein the operations further comprise:
selecting a plurality of revised preferred landing sites and setting a plurality of revised deviation perimeters in successive, discrete intervals while descending towards the ground area during the unplanned contingency landing,
wherein each of the revised preferred landing sites resides within the maximum deviation perimeter and all previously set revised deviation perimeters,
wherein each of the revised deviation perimeters are successively smaller.
